(19) United States
(12) Patent Application Publication
(10) Pub. No.: US 2012/0035286 A1
(43) Pub. Date: Feb. 9, 2012

(54) POLYMER MIXTURES COMPRISING HALOGEN

(75) Inventors: Ingo Bellin, Mannheim (DE); Klaus Hahn, Kirchheim (DE); Gregor Haverkemper, Ludwigshafen (DE); Horst Fischer, Hassloch (DE)

(73) Assignee: BASF SE, Ludwigshafen (DE)

(21) Appl. No.: 13/198,280

(22) Filed: Aug. 4, 2011

Related U.S. Application Data
(60) Provisional application No. 61/370,819, filed on Aug. 5, 2010.

(51) Int. Cl. C08J 9/35; C08L 25/06; C08L 55/02; C08L 53/02; C08L 25/12; C08L 25/14; C08K 5/103; C09K 21/08

(52) U.S. Cl. 521/88; 524/317; 252/609

(57) ABSTRACT

The invention relates to polymer mixtures comprising at least one polymer, at least one organic halogenated compound such as halogenated flame retardants and also at least one further compound to thermally stabilize the organic halogenated compound, this further compound having a saponification number of 80 to 300 mg KOH/g and an OH number of 200 to 800 mg KOH/g.

This patent application claims the benefit of pending U.S. provisional patent application Ser. No. 61/370,819 filed Aug. 5, 2010 incorporated in its entirety herein by reference.

The present invention relates to polymer mixtures comprising at least one polymer, at least one organic halogenated compound such as halogenated flame retardants, and also at least one further compound for thermal stabilization of the organic halogenated compound.

Polymers have now come to be used, as materials of construction, in very many sectors where the fire behavior of the materials used is also of crucial importance, for example building construction, furnishing and clothing textiles or vehicle construction. Accordingly, the polymers used must also satisfy the fire protection requirements particular to each sector.

Many polymers such as polyolefins, polyamides and polystyrenes are a fire hazard and therefore have to be additized with flame retardants for many uses in order that they may exhibit satisfactory fire behavior. The class of halogenated organic flame retardants is frequently used in polymers. Halogenated flame retardants work by releasing free halogen radicals at elevated temperatures. The free halogen radicals trap the free radicals involved in the free-radical chain reactions taking place in combustion and thereby interrupt the combustion process. The intermediates formed frequently include hydrohalides.

One issue with the use of halogenated organic flame-retardant compounds in polymers is that the polymers frequently have to be mixed with flame retardants at elevated temperatures in order that uniform distribution of the flame retardants in the polymer matrix may be achieved. In addition, the polymers are frequently processed in shape-conferring operations carried out at elevated temperatures. The temperatures required will frequently result in decomposition of some of the halogenated flame retardants used. In extrusion operations in particular, the thermosensitive flame retardants are exposed to distinct thermal stressors due to the residence time and local, shearing-induced temperature spikes. The additives may become degraded, reducing the amount actually active in the product. Moreover, the hydrohalide formed in the course of the degradation of the additives has a corrosive effect on the equipment used.

Prior artisans have therefore gone over to adding to the polymers, in addition to the halogenated organic flame retardant, a stabilizer intended to control the decomposition of the flame retardant in the course of the processing of the polymers.

WO 2005/103133 A1, for example, describes the addition of a thermally stabilizing amount of at least one acrylate or methacrylate polymer that melts in a temperature range from 50 to 150° C.

WO 98/16574 discloses the use of zeolite A as a thermal stabilizer for halogenated flame retardants.

US 2003/0195286 A1 discloses a flame retardant additive composition having improved thermal stability, comprising an alkyltin mercaptoalkanoate and a zeolite.

WO 98/16579 utilizes zinc compounds such as zinc stearate in combination with zeolites as thermal stabilizers.

EP 0 848 727 B1 describes flame-retardant compositions comprising hexabromocyclododecane and at least one halogenated epoxy resin as a thermal stabilizer for the hexabromocyclododecane.

Furthermore, the hydrohalides formed in the course of the decomposition of halogenated flame retardants can be trapped by means of acid scavengers, as mentioned in WO 2009/065880 for example. The acid scavengers used include, for example, hydroxides of magnesium, of aluminum or of zinc or else alkali metal carbonates or alkali metal bicarbonates.

Notwithstanding the existing thermal stabilizers for organic halogenated flame retardants, there is a need for further thermal stabilizers that exhibit good efficaciousness in respect of the stability of the flame retardants in the course of the processing of the polymers, and at the same time do not have an adverse effect on the protective effect of the flame retardants. The polymers additized with halogenated flame retardant and thermal stabilizer shall continue to exhibit good fire behavior.

We have found that this object is achieved by the use of compounds having a saponification number of 80 to 300 mg KOH/g and an OH number of 200 to 800 mg KOH/g to stabilize halogenated flame retardants and also by polymer mixtures comprising
(a) at least one polymer,
(b) at least one organic halogenated compound, and
(c) at least one compound having a saponification number of 80 to 300 mg KOH/g and an OH number of 200 to 800 mg KOH/g.

The inventors found that, surprisingly, compounds having a saponification number of 80 to 300 mg KOH/g and an OH number of 200 to 800 mg KOH/g provide distinctly better thermal stabilization to halogenated organic compounds, more particularly flame retardants, than many known compounds used for thermal stabilization of halogenated flame retardants, such as zeolite A, brominated epoxy resin or aluminum hydroxide. Prior art thermal stabilizers for halogenated organic flame retardants, moreover, can have such an adverse effect on the fire behavior of the polymers—which is supposed to be improved by adding the halogenated compounds—that relevant fire protection tests are failed. Polymers additized with halogenated organic flame retardants and, in accordance with the present invention, comprising component (c) to thermally stabilize the flame retardants, by contrast, do meet the appropriate requirements, as is exemplified with polystyrene foam.

The invention will now be particularly described.

One aspect of the present invention is the use of compounds (c) having a saponification number of 80 to 300 mg KOH/g and an OH number of 200 to 800 mg KOH/g to stabilize halogenated organic compounds, more particularly halogenated organic flame retardants. These compounds are used as component (c) in the polymer mixtures of the present invention.

It is preferable according to the present invention for (c) to have a saponification number in the range from 100 to 250 mg KOH/g and more preferably in the range from 120 to 220 mg KOH/g. It is likewise preferable according to the present invention for (c) to have a hydroxyl number in the range from 200 to 600 mg KOH/g and more preferably in the range from 220 to 500 mg KOH/g. It is very particularly preferable for (c) to have a saponification number in the range from 100 to 220 mg KOH/g and an OH number in the range from 200 to 600 mg KOH/g, and it is especially preferable for (c) to have a saponification number in the range from 120 to 200 mg KOH/g and an OH number in the range from 220 to 500 mg KOH/g.

Hydroxyl number for the purposes of the present invention is determined according to German standard specification DIN 53240. The OH number is the amount of potassium hydroxide in milligrams which is equivalent to the amount of acetic acid reacting with one gram of the sample substance in the course of an acetylation thereof.

Saponification number for the purposes of the present invention is determined according to DIN EN ISO 3681. Saponification is defined as the formation of potassium salts from derivatives of organic acids and saponification number is the amount of potassium hydroxide (KOH) in milligrams which is needed to saponify one gram of the in-test product.

When acid and/or epoxy groups are present in the compound to be analyzed, these groups have to be quantified in advance and have to be taken into account when determining the hydroxyl and/or saponification number. The amount of epoxy group can be determined according to ASTM D 1652-04 for example, and the amount of acid groups can be determined according to DIN EN 12634 for example.

According to the present invention, the at least one compound used as component (c) preferably comprises at most 1% by weight, preferably at most 0.5% by weight and more preferably at most 0.2% by weight of epoxy groups, based on the total weight of the compound, determined to ASTM 1652-04. Epoxy group for the purposes of the present invention is the entire epoxy radical of the formula —C(H)OC(H₂) having a molecular weight of 43 g/mol.

It is likewise preferable according to the present invention for the at least one compound used as component (c) to have an acid number of at most 15 mg KOH/g, preferably at most 10 mg KOH/g and more preferably at most 5 mg KOH/g, determined to DIN EN 12634.

It is particularly preferable according to the present invention for the at least one compound used as component (c) to comprise at most the above-indicated amounts of epoxy groups and at most the above-indicated acid numbers.

The at least one compound used as component (c) comprises carboxylic ester groups and free OH groups. In a particularly preferred embodiment of the present invention, the at least one compound used as component (c) merely comprises OH groups and carboxylic ester groups as functional groups. And said component (c) is most preferably selected from polyols partly esterified with carboxylic acids.

According to the present invention, a polyol is a compound having at least two OH groups. Polyols as defined include for example dihydric alcohols such as ethylene glycol, 1,2-propylene glycol, 1,3-propylene glycol, 1,4-butanediol, 1,3-butanediol, alcohols having 3 OH groups such as trimethylolmethane and glycerol, tetrahydric alcohols such as threitol, erythritol, sorbitan (cyclic anhydride of sorbitol) and pentaerythritol, pentahydric alcohols such as arabitol, adonitol and xylitol, hexahydric alcohols such as sorbitol, mannitol and dulcitol and sugars such as sucrose, trehalose and maltose.

Partly esterified is to be understood as meaning that at least one OH group is in esterified form and at least one OH group is in free form.

The carboxylic acid component of the partly esterified polyols may comprise for example low fatty acids having 1 to 6 carbon atoms such as formic acid, acetic acid, propionic acid, acrylic acid, butyric acid, isobutyric acid, crotonic acid, pentanoic acid, isovaleric acid, hexanoic acid, sorbic acid, medium fatty acids having 7 to 11 carbon atoms and higher fatty acids having 12 to 30 carbon atoms. Medium and higher fatty acids include for example enanthic acid (C7), caprylic acid (C8), pelargonic acid (C9), capric acid (C10), undecanoic acid (C11), lauric acid (C12), tridecanoic acid (C13), myristic acid (C14), pentadecanoic acid (C15), palmitic acid (C16), palmitoleic acid (C16), margaric acid (C17), stearic acid (C18), linoleic acid (C18), eleostearic acid (C18), oleic acid (C18), nonadecanoic acid (C19), arachinic acid (C20), arachidonic acid (C20), behenic acid (C22), erucic oil (C22), lignoceric acid (C24), cerotic acid (C26), melissic acid (C30). Fatty acids having 6 to 24 carbon atoms are preferred, more particularly lauric acid, palmitic acid, stearic acid and oleic acid.

When the at least one compound used as component (c) is selected from polyols partly esterified with carboxylic acids, the partly esterified esters may comprise compounds of a particular carboxylic acid with a particular polyol, but it is also possible to use mixed esters of various carboxylic acids with one variety of polyols, mixed esters of one carboxylic acid with various polyols, and also mixed esters formed from various carboxylic acids with various polyols.

Preferably (c) is selected from glycerol partly esterified with a carboxylic acid, sorbitol partly esterified with a carboxylic acid, mannitol partly esterified with a carboxylic acid, sucrose partly esterified with a carboxylic acid, maltose partly esterified with a carboxylic acid, trehalose partly esterified with a carboxylic acid, sorbitan partly esterified with a carboxylic acid and mixtures thereof.

Particular preference is given to selecting component (c) from polyols partly esterified with fatty acids, more preferably from polyols partly esterified with fatty acids having C6 to C24. The at least one compound used as component (c) is more preferably selected from the group consisting of glycerol partly esterified with a carboxylic acid, sorbitan partly esterified with a carboxylic acid, trehalose partly esterified with a carboxylic acid, sucrose partly esterified with a carboxylic acid, maltose partly esterified with a carboxylic acid, sorbitol partly esterified with a carboxylic acid, mannitol partly esterified with a carboxylic acid and mixtures thereof, more particularly from glycerol partly esterified with a fatty acid having C6 to C24, sorbitan partly esterified with a fatty acid having C6 to C24, trehalose partly esterified with a fatty acid having C6 to C24, sucrose partly esterified with a fatty acid having C6 to C24, maltose partly esterified with a fatty acid having C6 to C24, sorbitol partly esterified with a fatty acid having C6 to C24, mannitol partly esterified with a fatty acid having C6 to C24 and mixtures thereof.

It is particularly preferable according to the present invention for component (c) to be selected from sorbitan monopalmitate, sorbitan monostearate, sorbitan monooleate, sorbitan monolaurate, glycerol monopalmitate, glycerol monostearate, glycerol monooleate, glycerol monolaurate and mixtures thereof.

Component (c) may comprise one of the aforementioned compounds, but also mixtures of two or more thereof.

The polymer mixtures of the present invention comprise by way of component (b) at least one halogenated organic compound preferably comprising a halogenated organic flame retardant. Halogenated is to be understood as meaning in the context of the present invention that the compound in question comprises at least one substituent selected from the group consisting of F, Cl, Br and I. Preferably, the at least one organic halogenated compound used as component (b) is selected from the group consisting of brominated compounds and both brominated and chlorinated compounds, more particularly from brominated flame retardants and both brominated and chlorinated flame retardants.

It is preferable according to the present invention for component (b) to have a halogen content of at least 30% by weight, more preferably at least 40% by weight and most preferably at least 50% by weight, based on the organic halogenated compound.

Component (b) is preferably selected from the group consisting of brominated flame retardants and both brominated and chlorinated flame retardants where the bromine content and the bromine and chlorine content, respectively, is at least 30% by weight, more preferably at least 40% by weight and most preferably at least 50% by weight, based on the organic halogenated compound. Particular preference is given to aliphatic, cycloaliphatic and aromatic brominated and both chlorinated and brominated compounds. Particular preference is given to aliphatic, cycloaliphatic and aromatic bromine compounds having a bromine content of at least 30% by weight, more preferably at least 40% by weight and most preferably at least 50% by weight, based on the organic halogenated compound, such as hexabromocyclodecane, pentabromomonochlorocyclohexane, pentabromomonochlorocyclohexane, pentabromophenyl allyl ether, tetrabromobisphenol A and its ethers, tetrabromophthalic anhydride, dodecanechloropentacyclooctadecadiene (dechlorane), chloroparaffins, brominated diphenyl ethers such as pentabromodiphenyl ether, octabromodiphenyl ether and decabromodiphenyl ether and also brominated and both brominated and chlorinated styrene-butadiene copolymers. It is particularly preferable according to the present invention for component (b) to be selected from hexabromocyclododecane, brominated styrene-butadiene copolymers and both brominated and chlorinated styrene-butadiene copolymers. The styrene-butadiene copolymers are preferably in the form of block polymers.

The amount in which component (b) is used is generally in the range from 0.05% to 5% by weight, preferably in the range from 0.1% to 4% by weight and more preferably in the range from 0.5% to 2.5% by weight, based on the total weight of components (a), (b) and (c). The weight ratio of component (c) to the at least one organic halogenated compound is preferably in the range from 0.1 to 10.

The amount in which component (c) is used is preferably in the range from 0.05% to 5% by weight, preferably in the range from 0.1% to 4% by weight and more preferably in the range from 0.1% to 2.5% by weight, based on the total weight of components (a), (b) and (c).

The polymer mixture further comprises, by way of component (a), at least one polymer, and preferably the at least one polymer used as component (a) is thermoplastic. Polymers referred to as thermoplastics are typically uncrosslinked linear or branched polymers which, by a change in temperature, can be repeatedly converted into a flowable/formable state and solidified again. Thermoplastic polymers are frequently processed at comparatively high temperatures in a flowable/formable state, for example by injection molding and extrusion. It is particularly in relation to these processes that the flame retardants in the polymers have to be stabilized.

It is preferable according to the present invention for component (a) to be selected from homopolymers and copolymers comprising vinylaromatic monomer units, more particularly from homopolymers and copolymers constructed of vinylaromatic monomer units. Examples of vinylaromatic monomer units are styrene and C1- to C4-alkyl-substituted styrenes such as alpha-methylstyrene, beta-methylstyrene, o-methylstyrene, m-methylstyrene, p-methylstyrene and ethylstyrene.

Preference for use as components (a) is given to styrene homopolymers and styrene copolymers, more preferably crystal polystyrene (GPPS), high impact polystyrene (HIPS), anionically polymerized polystyrene or impact polystyrene (A-IPS), styrene-α-methylstyrene copolymers, acrylonitrile-butadiene-styrene polymer (ABS), styrene-acrylonitrile copolymers (SAN), acrylonitrile-styrene-acrylic ester copolymers (ASA), methacrylate-butadiene-styrene copolymers (MBS), methyl methacrylate-acrylonitrile-butadiene-styrene copolymers (MABS) or mixtures thereof or mixtures of the aforementioned styrenes and homopolymers and copolymers with polyphenylene ether (PPE).

The mentioned polymers and copolymers comprising vinylaromatic monomer units may be blended with further thermoplastic polymers such as polyamine (PA), polyolefins such as polypropylene (PP) or polyethylene (PE), polyacrylates such as polymethyl methacrylate (PMMA), polycarbonate (PC), polyesters such as polyethylene terephthalate (PET) or polybutylene terephthalate (PBT), polyether sulfones (PES), polyether ketones or polyether sulfides (PES) or mixtures thereof, generally in proportions of altogether up to no more than 30% by weight and preferably in the range from 1% to 10% by weight, based on the entire polymer mixture, with or without compatibilizers, to improve mechanical properties or for thermal stability. Mixtures in the quantitative range mentioned are further possible with, for example, hydrophically modified or functionalized polymers or oligomers, rubbers such as polyacrylates or polydienes, e.g., styrene-butadiene block copolymers or biodegradable aliphatic or aliphatic/aromatic copolyesters.

Useful compatibilizers include for example maleic anhydride-modified styrene copolymers, epoxy-containing polymers or organosilanes.

It is particularly preferable to select component (a) from expandable/expanded styrene polymers. So-called expandable polystyrene (EPS) or extruded polystyrene foam (XPS) may be concerned here for example. Expandable/expanded styrene polymers generally comprise one or more blowing agents in a homogeneous distribution in a fraction of altogether 2% to 10% by weight and preferably 3% to 7% by weight based on the polystyrene. Useful blowing agents include the physical blowing agents typically used in EPS and XPS such as aliphatic hydrocarbons having 2 to 7 carbon atoms, alcohols, ketones, ethers, carbon dioxide, water or halogenated hydrocarbons. Preference is given to using isobutane, n-butane, isopentane, n-pentane for EPS and CO₂, ethanol, water and fluorinated hydrocarbons for XPS.

The polymer mixture of the present invention preferably comprises

from 90% to 99.9% by weight of component (a),

from 0.05% to 5% by weight of component (b) and

from 0.05 to 5% by weight of component (c).

According to the present invention, the polymer mixture comprises more preferably

from 92% to 99.8% by weight of component (a),

from 0.1% to 4% by weight of component (b) and

from 0.1% to 4% by weight of component (c),

and most preferably

from 95% to 99.4% by weight of component (a),

from 0.5% to 2.5% by weight of component (b), and

from 0.1% to 2.5% by weight of component (c).

The % ages by weight are all based on the total weight of components (a), (b) and (c).

The polymer mixture may comprise, in addition to components (a) to (c), further additives customary in polymers, for example fillers, plasticizers, soluble and insoluble organic and/or inorganic dyes and pigments, athermanous compounds (e.g., graphite, carbon black, aluminum powder), and UV stabilizers and processing aids. The proportion thereof is generally in the range from 0% to 45%, preferably 0% to 20% and especially 0% (0.2% if present) to 10% by weight, based on the total weight of components (a), (b) and (c).

The polymer mixtures of the present invention are produced in a conventional manner by mixing the components. It may be advantageous to pre-mix individual components. Mixing the components in solution or suspension by removing the solvent/suspension medium is also possible. Solvent mixtures may be evaporated in evaporating extruders for example. Preferably, the components are mixed without a solvent at temperatures at which the polymer(s) used are meltable, for example by conjointly extruding, kneading or rolling the components.

Expandable, blowing agent-containing styrene polymers can be extruder produced and then granulated by the process of WO 2009/065880 A2 for example. Preferably this is done by metering components (b) and (c) conjointly. The two components can either be initially charged together with the styrene polymer, or else conjointly dispersed via a side stream extruder or in the form of a suspension and metered into the blowing agent-containing styrene polymer melt in the main stream and conjointly extruded through a die plate, preferably with subsequent underwater pelletization.

The process for producing the polymer mixtures of the present invention thus comprises the steps of
(i) providing component (a),
(ii) conjointly or separately adding components (b) and (c) to component (a), and
(iii) mixing the components.

The present invention further provides for the use of the above-described polymer mixtures in the manufacture of self-supporting film/sheet, intermediate articles, foams, fibers and moldings. The polymer mixtures of the present invention are processable by the known process of thermoplastics processing, for example by extruding, injection molding, calendering, blow molding or sintering.

The present invention also provides the corresponding self-supporting film/sheet, intermediate articles, foams, fibers and moldings comprising a polymer mixture as described above.

The present invention further provides for the use of the compounds (c) having a saponification number of 80 to 300 mg KOH/g and an OH number of 200 to 800 mg KOH/g to stabilize halogenated flame retardants.

The examples which follow illustrate the invention.

### A) Thermal Stability (Inventive Examples 1 to 8, Comparative Examples V1 to V11)

First, the suitability of various compounds for use as thermal stabilizers for organic, brominated flame retardants was tested by determining the HBr release at 200° C. similarly to the determination of the thermal stability of PVC (HCl release as per DIN 53381, Method B). To this end, a small amount of the in-test sample (halogenated organic flame retardant (b) with or without thermal stabilizer) was introduced into a test tube, which was closed with a rubber bung with two glass tubes. Nitrogen was introduced through one glass tube and redirected back out through the second glass tube. The exit gas stream was led through distilled water and the conductivity of the water was recorded as a function of time. The hydrogen halide forming in the course of the decomposition of the halogenated flame retardant is carried by the carrier gas stream into the water and increases the conductivity thereof. Stabilization is measured in terms of the stability time tₛₜ, which indicates the time by which the conductivity has changed by 50 μS*cm⁻¹.

The halogenated organic compounds used were the flame retardants hexabromocyclododecane (HBCD; CD 75-P from Chemtura Co.) and a brominated styrene-butadiene diblock copolymer (FR1; M_{w}: 56 000 g/mol, styrene block 37% by weight, 1,2-vinyl fraction 72%; obtained by example 8 of WO 2007/058736, having a Br content of about 60% by weight).

The thermal stabilizers used were zinc stearate (Sigma Aldrich), hydrotalcite (Kyowa Chemical Industry Co.), Al(OH)₃ (Nabaltec AG), glycerol tristearate (Sigma Aldrich), zeolite A (Sigma Aldrich), glycerol (Sigma Aldrich), glycidyl methacrylate copolymer (Joncryl ADR-4368 BASF SE), brominated epoxy resin (F2200 HM, ICL Industrial Products), Mg(OH)₂ (Albemerle Co.), sorbitan monolaurate (Sigma Aldrich), glycerol monostearate (Evonik Goldschmidt), glycerol monolaurate (Danisco), sorbitan monostearate (Sigma Aldrich), sorbitan monooleate (Sigma Aldrich), sorbitan monopalmitate (Sigma Aldrich) and glycerol monooleate (Sigma Aldrich).

Saponification number and hydroxide number of glycerol monostearate, sorbitan monostearate and sorbitan monolaurate were determined as set forth in the description. The results are shown in table 1.

TABLE 1

| | Saponification | OH |
|---|---|---|
| | number | number |
| Compound | [mg KOH/g] | [mg KOH/g] |
| glycerol monostearate | 156 | 315 |
| sorbitan monostearate | 151 | 253 |
| sorbitan monolaurate | 166 | 345 |

In each case 0.2 gram of thermal stabilizer was used per one gram of halogenated organic flame retardant. The results of the stability tests are summarized in table 2.

TABLE 2
influence of different stabilizers on stability of
brominated organic flame retardants

| | Flame | | tₛₜ |
|---|---|---|---|
| Example | retardant | Stabilizer | [min] |
| V1 (comparative) | 1 g of HBCD | — | 43 |
| V2 (comparative) | 1 g of FR1 | — | 83 |
| V2 (comparative) | 1 g of HBCD | 0.2 g of zinc stearate | 11 |
| V3 (comparative) | 1 g of HBCD | 0.2 g of hydrotalcite | 73 |
| V4 (comparative) | 1 g of HBCD | 0.2 g of Al (OH)₃ | 102 |
| V5 (comparative) | 1 g of HBCD | 0.2 g of glycerol stearate (GTS) | 120 |
| V6 (comparative) | 1 g of HBCD | 0.2 g of zeolite A | 143 |
| V7 (comparative) | 1 g of HBCD | 0.1 g of glycerol tristearate + | 153 |
| | | 0.1 g of glycerol | |
| V8 (comparative) | 1 g of HBCD | 0.2 g of glycidyl | 157 |
| | | methacrylate copolymer | |
| V9 (comparative) | 1 g of HBCD | 0.2 g of brominated epoxy resin | 168 |
| V10 (comparative) | 1 g of HBCD | 0.2 g of glycerol | 195 |
| V11 (comparative) | 1 g of HBCD | 0.2 g of Mg(OH)₂ | 270 |
| 1 (inventive) | 1 g of HBCD | 0.2 g of sorbitan monopalmitate | 222 |
| 2 (inventive) | 1 g of HBCD | 0.2 g of sorbitan monostearate | 228 |
| 3 (inventive) | 1 g of HBCD | 0.2 g of sorbitan monooleate | 230 |
| 4 (inventive) | 1 g of HBCD | 0.2 g of sorbitan monolaurate | 235 |
| 5 (inventive) | 1 g of HBCD | 0.2 g of glycerol monostearate | 299 |
| 6 (inventive) | 1 g of HBCD | 0.2 of glycerol monolaurate | 327 |
| 7 (inventive) | 1 g of HBCD | 0.2 g of glycerol monooleate | 404 |
| 8 (inventive) | 1 g of FR1 | 0.2 g of glycerol monostearate | 169 |

### B) Fire Behavior (Inventive Example 9, Comparative Examples V12 and V13)

Secondly, the B2 fire protection test of DIN 4102 was performed for various thermal stabilizers in HBCD-additized polystyrene foam.

To this end, first the corresponding expandable polystyrenes were produced by mixing 7% by weight of n-pentane into a polystyrene melt of PS 148G (viscosity number VN: 83 ml/g, BASF SE). After cooling the blowing agent-containing polystyrene melt from originally 260° C. down to a temperature of 190° C., a polystyrene melt comprising HBCD mixed with the particular stabilizer was mixed into the main stream via a side stream extruder. The mixture of polystyrene melt, blowing agent, flame retardant and thermal stabilizer was conveyed at a rate of 60 kg/h through a die plate having 32 holes (die diameter 0.75 mm). Pressurized underwater pelletization was used to obtain compact pellets of expandable polystyrene with narrow size distribution. The polystyrenes each comprised 2% by weight of flame retardant (HBCD) and 0.2% by weight of the in-test thermal stabilizer.

The pellets of expandable polystyrene were pre-foamed by exposure to a stream of steam and, after 12 hours of storage, fused in a closed mold by further treatment with steam to give foam slabs 15 kg/m³ in density.

The fire behavior of the foam slabs was tested, after 72 hours' storage, at a foam density of 15 kg/m³ as per DIN 4102. This test simulates the challenge posed by a small, defined flame (flame of a burning matchstick). Under this challenge, ignitability and flame spread have to be confined within a specified time. The test is carried out in a fire box equipped with a burner. The sample is exposed to a flame for 15 seconds before the flame is removed. The time between the start of exposure to the flame and the time at which the tip of the flame of the burning sample has reached a specified reference mark is measured, unless the flame self-extinguishes.

Results are reported in table 3.

TABLE 3
B2 fire test

| Ex. | Flame retardant | Stabilizer | B2 test |
|---|---|---|---|
| V12 | 2.0 parts of HBCD | 0.2 part of Mg (OH)2 | failed |
| V13 | 2.0 parts of HBCD | 0.2 part of hydrotalcite | failed |
| 9 | 2.0 parts of HBCD | 0.2 part of glycerol monostearate | passed |

It is clear from table 2 that the compounds having a saponification number of 80 to 300 mg KOH/g and an OH number of 200 to 800 mg KOH/g are very useful for stabilizing organic halogenated compounds. Apart from magnesium hydroxide, the compounds to be used according to the invention exhibit a distinctly greater lengthening of the time until the given amount of the halogenated compound is destroyed than the further thermal stabilizers known from the prior art. Especially the comparison of V5 (glycerol tristearate), V10 (glycerol) and V7 (equal proportions of glycerol tristearate and glycerol) shows that the effect is not simply due to the presence of free OH groups and carboxylic ester groups, but that both the functional groups have to be conjointly present in one compound in order that thermal stabilization of halogenated compounds may be achieved.

It is clear from table 3 that magnesium hydroxide, which proved to be the best non-inventive stabilizer for the stabilization of HBCD (see A, V11)), reduces the flame resistance of expanded polystyrene foam to such an extent that it does not pass the B2 test (B, V12). The same holds for the hydrotalcite known as thermal stabilizer from the prior art. Polystyrene foam additized with glycerol monostearate in accordance with the present invention exhibits very good stabilization (see A, example 5) and passes the B2 test (B, example 9).

1-18. (canceled)

19. A polymer mixture comprising
(a) at least one polymer,
(b) at least one organic halogenated compound, and
(c) at least one compound having a saponification number of 80 to 300 mg KOH/g and an OH number of 200 to 800 mg KOH/g.

20. The polymer mixture according to claim 19, wherein the at least one organic halogenated compound used as component (b) is a flame retardant.

21. The polymer mixture according to claim 19, wherein the polymer mixture comprises
from 90% to 99.9% by weight of (a),
from 0.05% to 5% by weight of (b), and
from 0.05% to 5% by weight of (c),
based on the total weight of said components (a), (b) and (c).

22. The polymer mixture according to claim 19, wherein the at least one compound used as component (c) comprises carboxylic ester groups and free OH groups.

23. The polymer mixture according to claim 19, wherein the at least one compound used as component (c) is a polyol partly esterified with carboxylic acids.

24. The polymer mixture according to claim 19, wherein the at least one compound used as component (c) is a polyol partly esterified with fatty acids.

25. The polymer mixture according to claim 19, wherein the at least one compound used as component (c) is selected from the group consisting of glycerol partly esterified with a carboxylic acid, sorbitan partly esterified with a carboxylic acid, trehalose partly esterified with a carboxylic acid, sucrose partly esterified with a carboxylic acid, maltose partly esterified with a carboxylic acid, sorbitol partly esterified with a carboxylic acid, mannitol partly esterified with a carboxylic acid and mixtures thereof.

26. The polymer mixture according to claim 19, wherein the at least one organic halogenated compound used as component (b) is a brominated compound or both brominated and chlorinated compound.

27. The polymer mixture according to claim 19, wherein the at least one organic halogenated compound used as component (b) is a brominated aliphatic compound,
a brominated cycloaliphatic compound,
a brominated aromatic compound,
a brominated and chlorinated aliphatic compound,
a brominated and chlorinated cycloaliphatic compound or
a brominated and chlorinated aromatic compound.

28. The polymer mixture according to claim 19, wherein the at least one organic halogenated compound used as component (b) is selected from the group consisting of hexabromocyclododecane, brominated styrene-butadiene copolymers and both brominated and chlorinated styrene-butadiene copolymers.

29. The polymer mixture according to claim 19, wherein the at least one polymer used as component (a) is thermoplastic.

30. The polymer mixture according to claim 19, wherein the at least one polymer used as component (a) is a homopolymer or a copolymer comprising vinylaromatic monomer units.

31. The polymer mixture according to claim 19, wherein the at least one polymer used as component (a) is a homopolymer or a copolymer constructed of vinylaromatic monomer units.

32. The polymer mixture according to claim 19, wherein the at least one polymer used as component (a) is expandable/expanded polystyrene.

33. A method for stabilizing an organic halogenated flame retardant which comprises adding at least one compound having a saponification number of 80 to 300 mg KOH/g and an OH number of 200 to 800 mg KOH/g to the flame retardant.

34. A process for producing the polymer mixture according to claim 19, which process comprises the steps of
(i) providing said component (a),
(ii) conjointly or separately adding said components (b) and (c) to said component (a), and
(iii) mixing the components.

35. A process for manufacturing self-supporting film/sheet, intermediate articles, foams, fibers and moldings containing the polymer mixture according to claim 19 comprising the step of thermoplastic processing of the polymer mixture.

36. Self-supporting film/sheet, intermediate articles, foams, fibers and moldings comprising the polymer mixture according to claim 19.
